(19) United States
(12) Patent Application Publication
(10) Pub. No.: US 2018/0030288 A1
(43) Pub. Date: Feb. 1, 2018

(54) NANOPARTICLE ENHANCED COATING FOR TRANSPARENT UV-RESISTANT FILMS AND RELATED METHODS AND COMPONENTS

(71) Applicant: METASHIELD, LLC, New York City, NY (US)

(72) Inventors: Michael R. Dahlby, Washington, UT (US); Cesar Ernesto Arevalo, Washington, UT (US); Glenn Allen Mesa, St. George, UT (US); William D. Bickmore, St. George, UT (US); Martin Ben-Dayan, New York City, NY (US)

(21) Appl. No.: 15/727,197

(22) Filed: Oct. 6, 2017

Related U.S. Application Data
(63) Continuation-in-part of application No. 15/341,615, filed on Nov. 2, 2016.
(60) Provisional application No. 62/405,699, filed on Oct. 7, 2016.
(60) Provisional application No. 62/405,132, filed on Oct. 6, 2016.
(60) Provisional application No. 62/327,160, filed on Apr. 25, 2016.
(60) Provisional application No. 62/265,156, filed on Dec. 9, 2015.
(60) Provisional application No. 62/249,628, filed on Nov. 2, 2015.

(51) Int. Cl. C09D 7/14; C09D 7/12; C09D 5/32; C08K 5/5435; C08K 5/5415

(52) U.S. Cl. CPC C09D 7/14; C08K 5/5435; C08K 5/5415; C09D 5/32; C09D 7/1266; C08K 2003/2213

(57) ABSTRACT

Various coating compositions, including silica based compositions, methods of preparing and using such compositions, and applications of such compositions are provided herein. In one embodiment, a process for incorporating UV-protecting nanoparticles into a sol-gel matrix along with resulting compositions and uses are described. In accordance with one embodiment, the nanoparticle synthesis and coating solution may be prepared in a single vessel, eliminating the need for additional processing steps. Applications of this process include, among other things, protective coatings for UV-sensitive materials such as wood, plastics, and dyes.

### CROSS-REFERENCE TO RELATED APPLICATIONS

This application claims benefit to U.S. Provisional Patent Application No. 62/405,699, filed Oct. 7, 2016, (attorney docket no. 78501.0031), the disclosure of which is incorporated by reference herein in its entirety. This application is also a continuation-in-part of, and claims priority to, U.S. patent application Ser. No. 15/341,615, which claims benefit to U.S. Provisional Application No. 62/249,628, filed Nov. 2, 2015, (attorney docket no. 78501.0015), U.S. Provisional Patent Application No. 62/265,156, filed Dec. 9, 2015, (attorney docket no. 78501.0026), U.S. Provisional Patent Application No. 62/327,160, filed Apr. 25, 2016, (attorney docket no. 78501.0027), and U.S. Provisional Patent Application No. 62/405,132, filed Oct. 6, 2016 (attorney docket no. 78501.0030), the disclosures of each of which are incorporated by references herein in their entireties.

### BACKGROUND

UV-resistant coatings are used to protect materials that are sensitive to the ultraviolet portion of the electromagnetic spectrum (e.g. that decay over extended periods of exposure to UV light). A few examples include wood, plastics, and materials containing dyes. Films enhanced with UV-absorbing nanoparticles such as cerium oxide, titanium dioxide, and zinc oxide make excellent coatings for these applications due to their selectively high absorption coefficient in the UV spectral range and low absorption coefficient in the visible range. In addition, the use of nanoparticles allows for a high concentration of UV absorbers in a very thin coating.

However, prior art methods of obtaining coatings embedded with nanoparticles rely on incorporating previously formed nanoparticles into a host matrix. This approach comes with several technical challenges. For example, nanoparticle synthesis often requires delicate synthetic conditions as well as a number of specialty chemicals to control particle size, size distribution, and stability. Nanoparticle synthesis also frequently requires the use of high temperatures, complicated apparatuses, and/or significant reaction times. Furthermore, if the nanoparticles are purchased from an outside vendor, shipping conditions must be carefully controlled to protect the nanoparticles (e.g. from high temperatures that can cause agglomeration and decomposition of the nanoparticles) during transit. All of these aspects reduce the cost effectiveness of such technology.

Another challenge is overcoming particle agglomeration when mixing pre-made nanoparticles into the coating solution. The unique properties exhibited by nanoparticles are typically a function of their size. Certain other properties may manifest when particular, consistent spacing between the nanoparticles is achieved. Agglomeration of the particles effectively negates these effects due to the change in effective size and spacing and renders the particles ineffective. In addition, high levels of agglomeration often result in loss of transparency of the coatings which may render the coating ineffective if transparency is a required attribute. This is an especially difficult task if the pre-made nanoparticles are procured in powder form.

These challenges could be mitigated if the nanoparticles could be made in situ. However, the conditions required for synthesis of nanoparticles are usually incompatible with conditions required for preparing the coating solution.

### BRIEF SUMMARY OF THE INVENTION

In accordance with the present disclosure, various embodiments are provided relating to silica-based coatings, including the preparation of solution-based UV-resistant coatings that maintain high transparency for visible wavelengths and concurrently synthesizes the UV-absorbing nanoparticles in-situ.

In accordance with one embodiment of the present disclosure, a method of forming a coating on a substrate is provided. The method comprises: stirring a first solution comprising a UV resistant material comprising a UV-absorbing nanoparticle prepared by a process of reacting a cerium salt with water, alcohol and a strong base; adding an acid capable of lowering the pH to a range of about pH 2-5 to the first solution to provide a second solution; adding to the second solution the following compounds to provide a third solution:

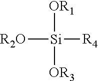

wherein R₁, R₂, R₃, are each independently selected from the group consisting of methyl, ethyl and propyl, and R₄ is selected from the group consisting of methyl, ethyl and propyl, vinyl, 3-glycidyloxypropyl, 3-aminopropyl;

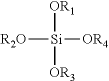

wherein R₁, R₂, R₃, and R₄ are each independently selected from the group consisting of methyl, ethyl and propyl; and applying the third solution to a substrate.

In accordance with one embodiment, the compounds added to the second solution are:

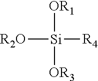

wherein R₁, R₂ and R₃ are methyl, and R₄ is 3-glycidyloxypropyl; and

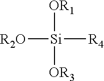

wherein R₁, R₂, R₃ are ethyl, and R₄ is methyl; and

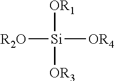

wherein R₁, R₂, R₃, and R₄ are ethyl.

In accordance with one embodiment, the acid is selected from the group consisting of acetic acid, oxalic acid, citric acid, and formic acid.

In accordance with one embodiment, the acid is acetic acid.

In accordance with one embodiment, the cerium salt is selected from the group consisting of one or more of cerium chloride, cerium bromide, cerium fluoride, cerium iodide, cerium nitrate.

In accordance with one embodiment, the cerium salt is cerium chloride.

In accordance with one embodiment, the strong base is selected from the group consisting of one or more of ammonium hydroxide, sodium hydroxide, lithium hydroxide, potassium hydroxide, rubidium hydroxide, cesium hydroxide, calcium hydroxide, strontium hydroxide, barium hydroxide.

In accordance with one embodiment, the strong base is selected from the group consisting of one or more of ammonium hydroxide, sodium hydroxide.

In accordance with one embodiment, wherein applying the sol-gel to a surface of a structure includes applying the third solution to glass, wood, polymer, metal, ceramic or a semiconducting material.

In accordance with one embodiment, applying the sol-gel to a surface of a structure includes dip-coating, spin-coating, spray-coating or forming a film of the sol-gel and applying the film to the surface of the structure.

In accordance with one embodiment, a pH of the first solution is approximately 9.

In accordance with one embodiment, a pH of the second solution is approximately 4.

In accordance with another embodiment of the present disclosure, a method of forming a coating on a substrate is provided. The method comprises: stirring a first solution comprising a UV resistant material comprising a UV-absorbing nanoparticle prepared by a process of reacting a cerium salt with water, alcohol and a strong base; adding an acid capable of lowering the pH to a range of about pH 2-5 to the first solution to provide a second solution; adding to the second solution the following compounds to provide a third solution:

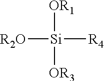

wherein R₁, R₂, R₃, are each independently selected from the group consisting of methyl, ethyl and propyl, and R₄ is selected from the group consisting of methyl, ethyl and propyl;

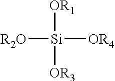

wherein R₁, R₂, R₃, and R₄ are each independently selected from the group consisting of methyl, ethyl and propyl; and

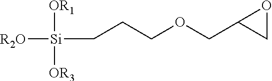

wherein R₁, R₂, and R₃ are each independently selected from the group consisting of methyl and ethyl; and applying the third solution to a substrate.

In accordance with one embodiment, the acid is acetic acid.

In accordance with one embodiment, the compounds added to the second solution are TEOS. MTEOS and GPTMS.

In accordance with one embodiment, the cerium salt is selected from the group consisting of one or more of cerium chloride, cerium bromide, cerium fluoride, cerium iodide, cerium nitrate.

In accordance with one embodiment, the cerium salt is cerium chloride.

In accordance with one embodiment, the strong base is selected from the group consisting of one or more of ammonium hydroxide, sodium hydroxide, lithium hydroxide, potassium hydroxide, rubidium hydroxide, cesium hydroxide, calcium hydroxide, strontium hydroxide, barium hydroxide.

In accordance with one embodiment, the strong base is selected from the group consisting of one or more of ammonium hydroxide, sodium hydroxide.

In accordance with another embodiment of the present disclosure, a composition is provided which is prepared by a process comprising the steps of combining the following compounds:

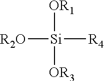

wherein R₁, R₂, R₃, are each independently selected from the group consisting of methyl, ethyl and propyl, and R₄ is selected from the group consisting of methyl, ethyl and propyl;

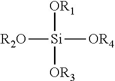

wherein R₁, R₂, R₃, and R₄ are each independently selected from the group consisting of methyl, ethyl and propyl;

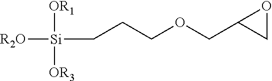

wherein R₁, R₂, and R₃ are each independently selected from the group consisting of methyl and ethyl; and a plurality of UV-absorbing nanoparticles, under conditions sufficient to produce a polysiloxane matrix.

In accordance with one embodiment, the plurality of UV-absorbing nanoparticles includes a plurality of cerium oxide nanoparticles.

In accordance with a further embodiment of the present disclosure, a structure is provided comprising: a substrate; a coating on a first surface of the substrate, the coating comprising a hybrid nanosilica (HNS) material prepared by the process of combining the following compounds:

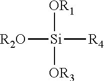

wherein R₁, R₂, R₃, are each independently selected from the group consisting of methyl, ethyl and propyl, and R₄ is selected from the group consisting of methyl, ethyl and propyl;

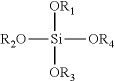

wherein R₁, R₂, R₃ and R₄ are each independently selected from the group consisting of methyl, ethyl and propyl;

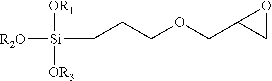

wherein R₁, R₂, and R₃ are each independently selected from the group consisting of methyl and ethyl; and a plurality of UV-absorbing nanoparticles, under conditions sufficient to produce a polysiloxane matrix.

In accordance with one embodiment, the plurality of UV-absorbing nanoparticles includes a plurality of cerium oxide nanoparticles.

In accordance with one embodiment, the substrate comprises a glass material.

In accordance with one embodiment, the substrate comprises a material including at least one of the group consisting of: wood, metal, polymer, ceramic and semiconducting material.

In accordance with yet another embodiment of the present disclosure, a coating composition is provided which comprises: a hybrid nanosilica (HNS) material prepared by the process of combining the following compounds:

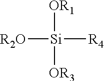

wherein R₁, R₂, R₃, are each independently selected from the group consisting of methyl, ethyl and propyl, and R₄ is selected from the group consisting of methyl, ethyl and propyl;

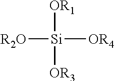

wherein R₁, R₂, R₃ and R₄ are each independently selected from the group consisting of methyl, ethyl and propyl; and

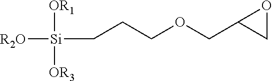

wherein R₁, R₂, and R₃ are each independently selected from the group consisting of methyl and ethyl.

Various features, components or aspects of any embodiment described herein may be combined with other embodiments or other features components or aspects of other embodiments described herein.

### BRIEF DESCRIPTION OF THE SEVERAL VIEWS OF THE DRAWINGS

The foregoing and other advantages of the various embodiments of the present disclosure will become apparent upon reading the following detailed description and upon reference to the drawings in which:

FIG. 1 is a flow chart depicting a method according to an embodiment of the present disclosure;

FIG. 2 is a graph showing the transmission of various wavelengths of light through a coating formed in accordance with an embodiment of the present disclosure; and

FIG. 3 is an image from a dark-field microscope showing nanoparticles embedded in a matrix material according to an embodiment of the present disclosure.

### DETAILED DESCRIPTION OF THE INVENTION

Embodiments of the present disclosure provide a UV-resistant coating or film for use on various articles and, in various embodiments, may overcome some or all of the challenges described above by synthesizing nanoparticles, in such a way that enables the nanoparticle synthesis solution to be directly incorporated into a coating solution.

The coating solution may include those described in U.S. Provisional Patent Application No. 62/249,628 (attorney docket no. 78501.0015) filed on Nov. 2, 2015, U.S. Provisional Patent Application No. 62/265,156 (attorney docket number 78501.0026) filed on Dec. 9, 2015 and U.S. Provisional Patent Application No. 62/327,160 (attorney docket no. 78501.0027) filed on Apr. 25, 2016, and/or U.S. Provisional Patent Application No. 62/405,123 (attorney docket no. 78501.0030) filed on Oct. 6, 2016, the disclosures of each of which are incorporated by reference herein in their entireties.

Thus, for example, a coating solution may include nanosilica composition or material, sometimes referred to as a hybrid nanosilica (HNS) material. An HNS material may be used to form coatings that are unlike conventional petroleum based polymers, varnishes, lacquers or paints in that the HNS coatings are composed of chains of organically substituted silica chemically linked together to form an extensive organic-inorganic based material. The resultant solution is a highly transparent liquid that, under proper conditions, undergoes a sol-gel morphological transformation causing it to harden into a solid glass-like film. Compositions described herein may be used as a coating or may be used to form a cast, molded, or other stand-alone structure. Various novel characteristics, including impact resistance, are further described in patent applications previously incorporated by reference.

Embodiments of the present disclosure provide a group of coatings that have a multitude of potential benefits. For example, HNS materials (a base hybrid organic-inorganic silica-based material) comprises a material made from sol-gel hydrolysis and condensation reactions. Precursors to form such films may be chosen from the tetraalkoxysilanes and organically substituted trialkoxysilanes, including the in-situ formation of new organically substituted trialkoxysilanes from additional cross-linking organic molecules such as diamines. In some embodiments, additional cross-linking organic molecules may include, for example, 1,8-diaminooctane (ODA) or 1,4-diaminobutane (BDA). The precursors result in a stand-alone coating or a coating that may serve as a matrix for embedding nanoparticles—such as metals, semiconductors, and metal-oxides—to add additional properties.

In various embodiments, the base HNS coatings, may exhibit thicknesses ranging from less than 100 nm up to hundreds of microns, are optically transparent and can be relatively hard when cross-linkers are included. The wettability (hydrophilicity, hydrophobicity, oleophobicity, omniphobicity, etc.) is easily tailored by modifying the organically substituted trialkoxysilanes to produce coatings that exhibit self-cleaning and antifogging properties. HNS coatings can adopt other optical and physical properties when doped with nanoparticles including but not limited to ultraviolet (UV) attenuation, antireflection, formation of plasmons, and biological deterrence.

The coatings described herein may be used for various applications. Some non-limiting examples include increasing the break strength of glass and other substrates, making substrates more scratch resistant, increasing efficiency of photovoltaic devices, and extending the lifetime of substrates by preventing ultra-violet degradation and chemical corrosion.

As previously noted, in some embodiments, the HNS composition (or compound) may include or otherwise serve as a matrix for other nanoparticles such as, for example, UV-resistant nanoparticles. In accordance with one embodiment, the silica nanoparticles used to form the matrix may be formed using a sol-gel method (e.g., acid or base catalyzed) using tetraethylorthosilicate (TEOS), methyltrimethoxysilane (MTEOS), and (3-glycidyloxypropyl)trimethoxysilane (GPTMS). The TEOS, MTEOS, and GPTMS may go through a hydrolysis and then a condensation reaction to form a silica based matrix with methyl and epoxide functional groups (see, e.g., Chemical Expression 1 below). These epoxide functional groups may be used in conjunction with diamine or amine that may include, for example, 1,4-butyldiamine (BDA) to link together. (See Chemical Expression 2 below. Note that only half of the cross-linking reaction is shown for purposes of convenience and clarity). BDA has two amine groups on either end of the molecule, and each amine group can react with an epoxide group to attach the HNS in which other materials may be dispersed or embedded as discussed below.

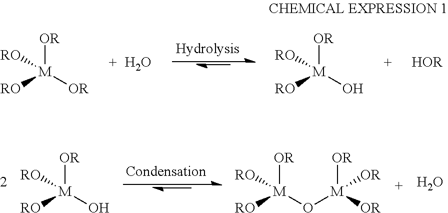

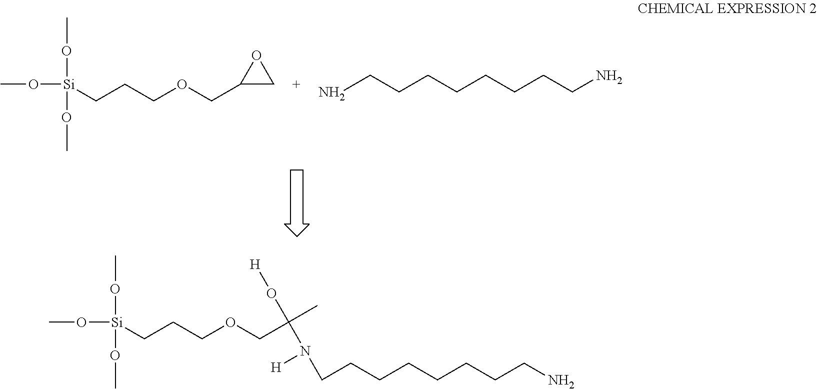 [SMILES: CO[Si](CCCOCC1CO1)(OC)OC ; NCCCCCCCCN ; CO[Si](CCCOCC(C)(O)NCCCCCCCCN)(OC)OC]

In one embodiment, the HNS compound is a complex mixture of organically-substituted silica chains (i.e. acid catalyzed) chemically linked together to form an extensive organic-inorganic matrix. In another embodiment, organically-substituted silica nanoparticles (i.e. base catalyzed) and an amine cross linker (e.g. a diamine or an alkoxy silane featuring an amine group that reacts with the epoxide functional group on GPTMS) are combined to create the organic-inorganic silica network. In some embodiments, the HNS compound is a combination of silica ingredients which are liquid prior to and during application of the compound to a given surface (e.g. a glass substrate), becoming solid after coating a structure and being exposed to relatively low temperatures (e.g. temperatures associated with ordinary sunlight). This is also known as a sol-gel change of state.

The sol-gel process begins with monomer hydrolysis followed by condensation between two or more monomers to form oligomers consisting of several silicon and oxygen atoms. As condensation continues, the resulting morphology is determined by the pH of the solution. Under acidic conditions (i.e. pH less than 7), condensation proceeds via oligomers linking together to form long chains, whereas under basic conditions (i.e. pH greater than 7) condensation proceeds in a fashion where the oligomers grow independently to form discrete particles. Both acidic and basic preparations are amenable to film formation. However, films prepared from basic solutions with discrete particles tend to yield rough, brittle films. This challenge can be overcome with the use of a crosslinker to improve inter-particle bonding.

Unlike conventional petroleum-based polymers, the resulting coating is very hard, durable, and highly resistant to sunlight degradation. In one embodiment, the coating exhibits a hardness of at least approximately 5.0 on the Mohs hardness scale. In another embodiment, the coating may exhibit a hardness of approximately 5.5 to approximately 6.5 on the Mohs hardness scale, or even greater. Stated another way, in some embodiments, the coating may exhibit a hardness that is similar to that of steel. Additionally, the coating provides substantial abrasion resistance, as shown through sand blasting and other simulated environments. Thus, in accordance with certain embodiments of the present disclosure, HNS coatings and films are capable of providing a highly transparent surface through which light may be efficiently transmitted despite exposure to various environmental conditions. In its native form, HNS coatings or films are highly transparent across a wide sector of the solar spectrum, ranging from near-infrared to ultraviolet, and including the UV-a and UV-b spectra.

In some embodiments, hydrophobic, hydrophilic or oleophobic chemistry may further be added to the HNS compound. For example, methyl triethoxysilane, (3-glycidyloxypropyl) trimethoxysilane, hexamethyldisilazane or other organic silanes may be added for purposes of providing a material that exhibits hydrophobic characteristics. In another example, poly(ethylene glycol) silane or other similar chemicals may be added for purposes of providing a composition with hydrophilic characteristics. The use of hydrophobic, hydrophilic and/or oleophobic additives has been shown to decrease the buildup of precipitation deposited minerals and reduce the tendency of water to form a bead on a given surface (e.g., from precipitation or dew). Hydrophobic coatings reduce the volume of water on a given surface. Likewise, an oleophobic coating reduces the volume of oil on a given surface. The hydrophilic coatings help spread out water with a low contact angle between the surface and the water. In all cases (hydrophilic, hydrophobic, and oleophobic) the residual mineralization or negative byproducts will be minimized compared to structures and devices without a similar coating.

In one particular embodiment, the above chemistry may be altered by adding hydrophobic elements such as methyltriethoxysilane, vinyltriethoxysilane, octyltriethoxysilane, phenyltriethoxysilane or any other silane precursor with hydrophobic characteristics. In another embodiment of the present disclosure, the above chemistry is additionally modified (or alternatively modified) by replacing tetraethyl orthosilicate with tetramethyl orthosilicate.

Thus, in accordance with one embodiment of the present disclosure, a coating composition may comprise a hybrid organic-inorganic material made from the hydrolysis and condensation of a metal alkoxide and organically substituted metal alkoxides in the presence of water and optionally a catalyst. The resulting material is linked together through bridging oxygen atoms.

In accordance with one embodiment of the present disclosure, a coating composition may include a hybrid organic-inorganic silica-based material made from the hydrolysis and condensation of a tetraalkoxysilane and an organically substituted trialkoxysilane in the presence of water and a catalyst resulting in a material comprising SiO₄ tetrahedra, SiO₃(alkyl) tetrahedra, and SiO₃(epoxide) tetrahedra linked together through bridging oxygen atoms.

In accordance with one embodiment of the present disclosure, a coating composition comprises a hybrid organic-inorganic silica-based material made from the hydrolysis and condensation of one or more of the following: a tetraalkoxysilane, alkyl trialkoxysilane, and epoxide functionalized siloxanes in the presence of water and a catalyst resulting in a material comprising SiO₄ tetrahedra, SiO₃(alkyl) tetrahedra, and SiO₃(epoxide) tetrahedra linked together through bridging oxygen atoms.

In accordance with one embodiment of the present disclosure, a coating composition comprises a hybrid nanosilica (HNS) material made from the hydrolysis and condensation of tetraethylorthosilicate (TEOS), methyl triethoxysilane (MTEOS), and (3-glycidoxypropyl)trimethoxysilane (GPTMS) in the presence of water and a catalyst resulting in a material comprising SiO₄ tetrahedra, SiO₃(CH₄) tetrahedra, and SiO₃(CH₂CH₂CH₂O CH₂CH CH₂O) tetrahedra linked together through bridging oxygen atoms.

In accordance with one embodiment of the present disclosure, a coating composition comprises a hybrid nanosilica material made from tetraethylorthosilicate (TEOS), methyl triethoxysilane (MTEOS) and glycidoxypropyltrirnethoxysilane (GPTMS).

In accordance with one embodiment of the present disclosure a coating composition comprises a coating on a first surface of the substrate, the coating comprising a hybrid nanosilica (HNS) material prepared by the process of combining the following compounds:

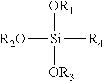

wherein R₁, R₂, R₃, are each independently selected from the group consisting of methyl, ethyl and propyl, and R₄ is selected from the group consisting of methyl, ethyl and propyl;

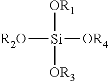

wherein R₁, R₂, R₃ and R₄ are each independently selected from the group consisting of methyl, ethyl and propyl; and

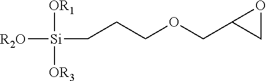

wherein R₁, R₂, and R₃ are each independently selected from the group consisting of methyl and ethyl.

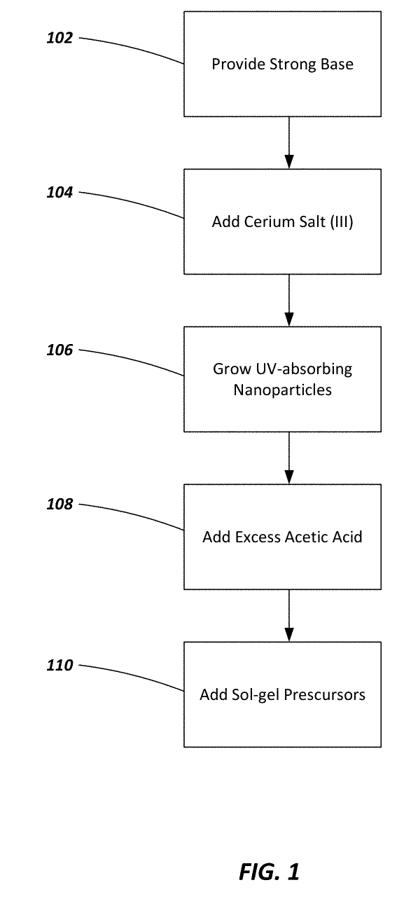

Embodiments of the present disclosure may combine a process used to synthesize the nanoparticles and the method of producing a solution used for a coating material into a single, unified process. For example, referring to FIG. 1, a strong base is provided for the synthesis of UV-absorbing nanoparticles as indicated at block 102. The base may include the solvent system that is required for the coating solution. As indicated at block 104, a cerium salt may be added to the base to grow the nanoparticles in situ. The nanoparticles may be grown for a specified amount of time as indicated at block 106. For example, in some embodiments, such UV-absorbing nanoparticles may be formed in little as one minute to three minutes. The reaction is quenched using an excess of weak acid such as acetic acid, as indicated at block 108, resulting in a solution pH amenable to film formation by the sol-gel reactions without risking the formation of any salts. Sol-gel precursor compounds may then be added to form the host matrix (e.g., such as an HNS composition) around the UV absorbing nanoparticles as indicated at block 110.

According to embodiments of the disclosure, UV absorbing films may be produced that maintain high transparency in the visible range of wavelengths. For example, cerium oxide nanoparticles may be prepared using a precursor salt such as cerium (III) chloride heptahydrate or cerium (III) nitrate hexahydrate. Other metal oxides such as zinc oxide and titanium dioxide that absorb light in the UV range may also be prepared in a similar fashion.

Considering an embodiment utilizing cerium salt as a precursor, the precursor salt is added to a solution comprising water, a homogenizing solvent such as an alcohol (ethyl, propyl, butyl, etc.), and a strong base such as ammonium hydroxide or sodium hydroxide. The pH of the solution may be approximately 9 or higher. Once the cerium salt is combined with the basic solution, a weak acid such as acetic acid may be added after a time period ranging, for example, from 1-3 minutes to quench particle growth and, at the same time, to produce an acidic environment amenable to sol-gel film formation upon its application to a substrate or other structure.

After addition of the weak acid, alkoxysilane and organoalkoxysilane such as tetraethyl orthosilicate (TEOS), methyl triethoxy silane, and any other compound that undergoes the typical sol-gel reactions, may be added. After stirring for a specified time (e.g., approximately 1-3 hours), the solution may be used to coat a substrate (e.g. by way of drop-, dip-, or spray-coating), or it may be cast into a mold to form monolithic structures for subsequent application to a structure, or it may be applied in any other fashion that allows for the sol-gel reactions to form a solid material.

In other embodiments, where other precursor elements are utilized to form UV-absorbing nanoparticles in-situ, adjustments may be made to the process to control the pH levels and the speed of the reactions. For example, the reactivity of cerium ions is such that they require a basic environment to promote the growth of nanoparticles, whereas the reactivity of titanium ions is considerably greater and will require a highly acidic environment in order to slow down the reaction. Therefore, if using a titanium material as a precursor for growing titanium oxide nanoparticles, a step may be included in the process to raise the pH to a level amenable for the siloxane chemistry to occur (in contrast to lowering the pH in the case of the formation of cerium oxide. Similarly, in using a zinc material as a precursor to obtain zinc oxide particles, a step may be included in the process to appropriately adjust the pH (e.g., raise) to a level amenable for the siloxane chemistry to occur.

In accordance with one embodiment of the present disclosure, a coating composition may formed by stirring a first solution comprising a UV-absorbing nanoparticle prepared by a process of reacting a cerium salt with water, alcohol and a strong base. Acid, capable of lowering the pH to a range of about pH 2-5, is added to the first solution to provide a second solution. The following compounds are then added to the second solution to provide a third solution:

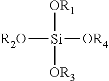

wherein R₁, R₂, R₃, are each independently selected from the group consisting of methyl, ethyl and propyl, and R₄ is selected from the group consisting of methyl, ethyl and propyl, vinyl, 3-glycidyloxypropyl, 3-aminopropyl; and

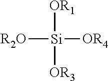

wherein R₁, R₂, R₃, and R₄ are each independently selected from the group consisting of methyl, ethyl and propyl.

In accordance with one embodiment, the compounds added to the second solution are:

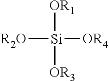

wherein R₁, R₂, R₃, are methyl, and R₄ is 3-glycidyloxypropyl; and

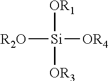

wherein R₁, R₂, R₃, are ethyl, and R₄ is methyl; and

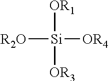

wherein R₁, R₂, R₃, and R₄ are ethyl.

In one embodiment, the acid used to lower the pH may include acetic acid, oxalic acid, citric acid, and formic acid.

In one embodiment, the cerium salt may include one or more of cerium chloride, cerium bromide, cerium fluoride, cerium iodide, cerium nitrate.

In accordance with one embodiment of the present disclosure, a coating composition may be formed by stirring a first solution comprising a UV-absorbing nanoparticle prepared by a process of reacting a cerium salt with water, alcohol and a strong base. Acid, capable of lowering the pH to a range of about pH 2-5, is added to the first solution to provide a second solution. The following compounds are then added to the second solution to provide a third solution:

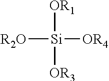

wherein R₁, R₂, R₃, are each independently selected from the group consisting of methyl, ethyl and propyl, and R₄ is selected from the group consisting of methyl, ethyl and propyl;

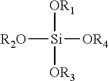

wherein R₁, R₂, R₃, and R₄ are each independently selected from the group consisting of methyl, ethyl and propyl; and

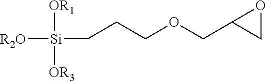

wherein R₁, R₂, and R₃ are each independently selected from the group consisting of methyl and ethyl.

In one embodiment, the acid is acetic acid.

In one embodiment, the compounds added to the second solution are TEOS. MTEOS and GPTMS.

In one embodiment, the cerium salt may include one or more of cerium chloride, cerium bromide, cerium fluoride, cerium iodide, cerium nitrate.

In one embodiment, the strong base may include one or more of ammonium hydroxide, sodium hydroxide, lithium hydroxide, potassium hydroxide, rubidium hydroxide, cesium hydroxide, calcium hydroxide, strontium hydroxide, barium hydroxide.

In accordance with one embodiment of the present disclosure, a composition is prepared by a process comprising the steps of combining the following compounds:

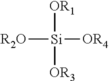

wherein R₁, R₂, R₃, are each independently selected from the group consisting of methyl, ethyl and propyl, and R₄ is selected from the group consisting of methyl, ethyl and propyl;

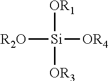

wherein R₁, R₂, R₃, and R₄ are each independently selected from the group consisting of methyl, ethyl and propyl;

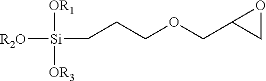

wherein R₁, R₂, and R₃ are each independently selected from the group consisting of methyl and ethyl; and a plurality of UV-absorbing nanoparticles, under conditions sufficient to produce a polysiloxane matrix.

In one embodiment, the plurality of UV-absorbing nanoparticles includes a plurality of cerium oxide nanoparticles.

The various coating compositions described herein may be used on any of a variety of surfaces including, for example, wood, metal, polymer, ceramic and semiconducting material. Various techniques of applying the sol-gel to a surface of a structure include dip-coating, spin-coating, spray-coating or forming a film of the sol-gel and applying the film to the surface of the structure. Various other materials on which the coatings may be applied, techniques for applying such coatings, and various example applications or utilizations of such coatings, may be found in the previously incorporated priority documents.

### UV-Resistant Composition Example

Cerium chloride heptahydrate having a mass of 0.042 grams was added to a solution of 12.5 milliliters of water, 26.2 milliliters of ethanol, and 100 microliters of ammonium hydroxide. The pH of the solution was 9.

The solution was then stirred at room temperature for a period of two minutes, during which the solution became an increasingly darker orange/brown color. At that time, 500 microliters of acetic acid was added, resulting in a pH decrease to 4 and a change in color to bright yellow.

Additional components were then added to the solution including 0.6 milliliters of TEOS, 1.3 milliliters of MTEOS, and 0.4 mL of GPTMS. The combined solution was stirred for an additional 3 hours at room temperature before drop-casting onto either glass substrates or photovoltaic devices.

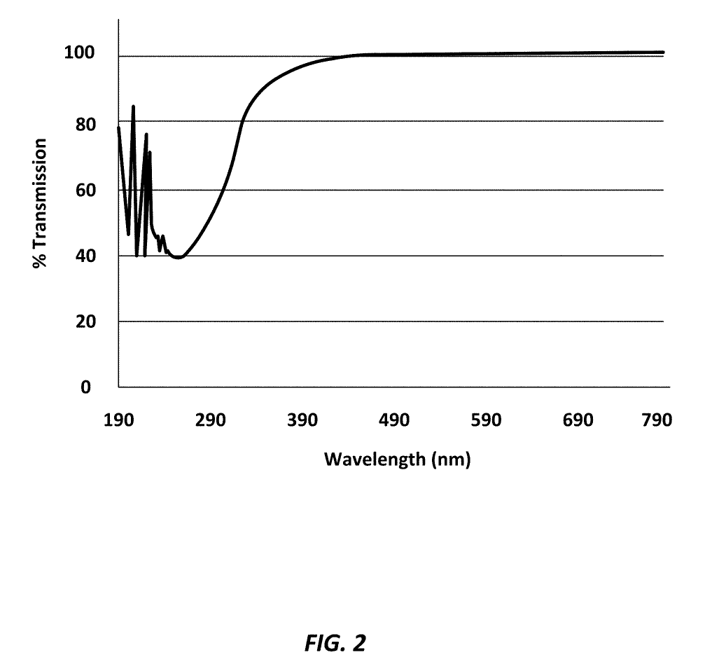

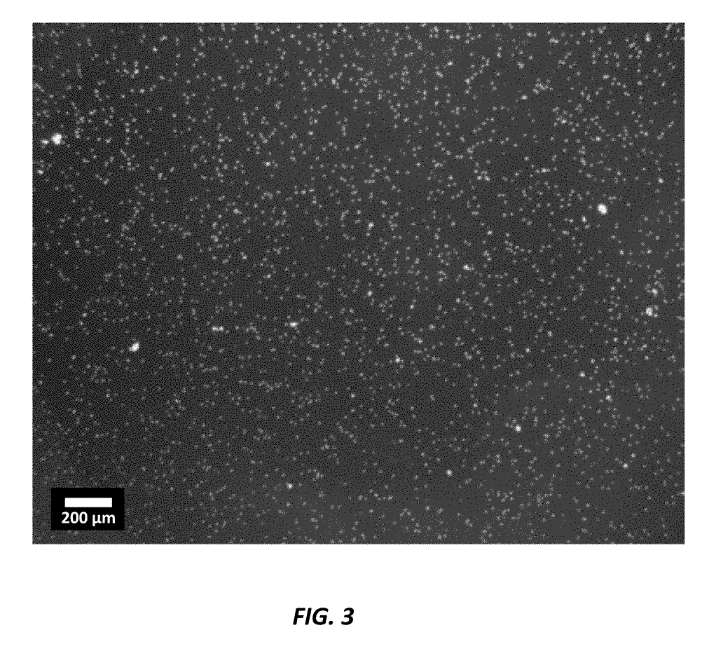

Coatings of approximately 20 micrometer thickness resulted with a cerium:silicon molar ratio of 1 percent and exhibited a highly transparent coating. FIG. 2 shows a graph with transmission testing data for the coatings, indicating blocking or absorption of light in UV ranges but effective transmission of light at visible wavelengths. FIG. 3 is a photo-micrograph of the coating material of showing the spacing of nanoparticles embedded in a matrix material.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A method of forming a coating on a substrate, the method comprising:
stirring a first solution comprising a UV resistant material comprising a UV-absorbing nanoparticle prepared by a process of reacting a cerium salt with water, alcohol and a strong base;
adding an acid capable of lowering the pH to a range of about pH 2-5 to the first solution to provide a second solution;
adding to the second solution the following compounds to provide a third solution: 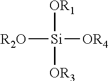
wherein R₁, R₂, R₃, are each independently selected from the group consisting of methyl, ethyl and propyl, and R₄ is selected from the group consisting of methyl, ethyl and propyl, vinyl, 3-glycidyloxypropyl, 3-aminopropyl; 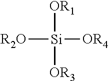
wherein R₁, R₂, R₃, and R₄ are each independently selected from the group consisting of methyl, ethyl and propyl; and
applying the third solution to a substrate.

2. The method of claim 2, wherein the compounds added to the second solution are 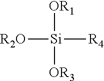
wherein R₁, R₂ and R₃ are methyl, and R₄ is 3-glycidyloxypropyl; and 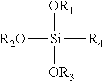
wherein R₁, R₂, R₃ are ethyl, and R₄ is methyl; 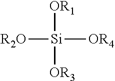
wherein R₁, R₂, R₃, and R₄ are ethyl.

3. The method of claim 1, wherein the acid is selected from the group consisting of acetic acid, oxalic acid, citric acid, and formic acid.

4. The method of claim 1, wherein the acid is acetic acid.

5. The method of claim 1, wherein the cerium salt is selected from the group consisting of one or more of cerium chloride, cerium bromide, cerium fluoride, cerium iodide, cerium nitrate.

6. The method of claim 1, wherein the cerium salt is cerium chloride.

7. The method of claim 1, wherein the strong base is selected from the group consisting of one or more of ammonium hydroxide, sodium hydroxide, lithium hydroxide, potassium hydroxide, rubidium hydroxide, cesium hydroxide, calcium hydroxide, strontium hydroxide, barium hydroxide.

8. The method of claim 1, wherein the strong base is selected from the group consisting of one or more of ammonium hydroxide, sodium hydroxide

9. The method according to claim 1, wherein applying the sol-gel to a surface of a structure includes applying the third solution to glass, wood, polymer, metal, ceramic or a semiconducting material.

10. The method according to claim 1, wherein applying the sol-gel to a surface of a structure includes dip-coating, spin-coating, spray-coating or forming a film of the sol-gel and applying the film to the surface of the structure.

11. The method according to claim 1, wherein a pH of the first solution is approximately 9.

12. The method according to claim 1, wherein a pH of the second solution is approximately 4.

13. A method of forming a coating on a substrate, the method comprising:
stirring a first solution comprising a UV resistant material comprising a UV-absorbing nanoparticle prepared by a process of reacting a cerium salt with water, alcohol and a strong base;
adding an acid capable of lowering the pH to a range of about pH 2-5 to the first solution to provide a second solution;
adding to the second solution the following compounds to provide a third solution: 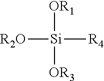
wherein R₁, R₂, R₃, are each independently selected from the group consisting of methyl, ethyl and propyl, and R₄ is selected from the group consisting of methyl, ethyl and propyl; 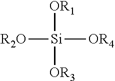
wherein R₁, R₂, R₃, and R₄ are each independently selected from the group consisting of methyl, ethyl and propyl; and 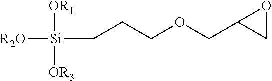
wherein R₁, R₂, and R₃ are each independently selected from the group consisting of methyl and ethyl;
applying the third solution to a substrate.

14. The method of claim 13 wherein the acid is acetic acid.

15. The method of claim 13, wherein the compounds added to the second solution are TEOS. MTEOS and GPTMS.

16. The method of claim 13, wherein the cerium salt is selected from the group consisting of one or more of cerium chloride, cerium bromide, cerium fluoride, cerium iodide, cerium nitrate.

17. The method of claim 16, wherein the cerium salt is cerium chloride.

18. The method of claim 13, wherein the strong base is selected from the group consisting of one or more of ammonium hydroxide, sodium hydroxide, lithium hydroxide, potassium hydroxide, rubidium hydroxide, cesium hydroxide, calcium hydroxide, strontium hydroxide, barium hydroxide.

19. The method of claim 18, wherein the strong base is selected from the group consisting of one or more of ammonium hydroxide, sodium hydroxide.

20. A composition prepared by a process comprising the steps of combining the following compounds: 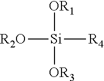
wherein R₁, R₂, R₃, are each independently selected from the group consisting of methyl, ethyl and propyl, and R₄ is selected from the group consisting of methyl, ethyl and propyl; 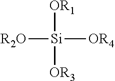
wherein R₁, R₂, R₃, and R₄ are each independently selected from the group consisting of methyl, ethyl and propyl; 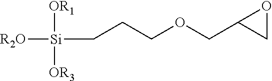
wherein R₁, R₂, and R₃ are each independently selected from the group consisting of methyl and ethyl; and
a plurality of UV-absorbing nanoparticles, under conditions sufficient to produce a polysiloxane matrix.

21. The composition of claim 20, wherein the plurality of UV-absorbing nanoparticles includes a plurality of cerium oxide nanoparticles.

22. A structure comprising:
a substrate;
a coating on a first surface of the substrate, the coating comprising a hybrid nanosilica (HNS) material prepared by the process of combining the following compounds 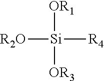
wherein R₁, R₂, R₃, are each independently selected from the group consisting of methyl, ethyl and propyl, and R₄ is selected from the group consisting of methyl, ethyl and propyl; 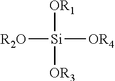
wherein R₁, R₂, R₃ and R₄ are each independently selected from the group consisting of methyl, ethyl and propyl; 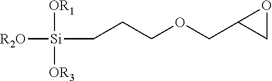
wherein R₁, R₂, and R₃ are each independently selected from the group consisting of methyl and ethyl; and
a plurality of UV-absorbing nanoparticles, under conditions sufficient to produce a polysiloxane matrix.

23. The structure of claim 22, wherein the plurality of UV-absorbing nanoparticles includes a plurality of cerium oxide nanoparticles.

24. The structure of claim 22, wherein the substrate comprises a glass material.

25. The structure of claim 22, wherein the substrate comprises a material including at least one of the group consisting of: wood, metal, polymer, ceramic and semiconducting material.

26. A coating composition:
a hybrid nanosilica (HNS) material prepared by the process of combining the following compounds 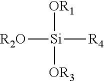
wherein R₁, R₂, R₃, are each independently selected from the group consisting of methyl, ethyl and propyl, and R₄ is selected from the group consisting of methyl, ethyl and propyl; 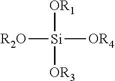
wherein R₁, R₂, R₃ and R₄ are each independently selected from the group consisting of methyl, ethyl and propyl; and 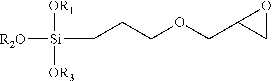
wherein R₁, R₂, and R₃ are each independently selected from the group consisting of methyl and ethyl.
